(19) United States
(12) Patent Application Publication
(10) Pub. No.: US 2022/0082185 A1
(43) Pub. Date: Mar. 17, 2022

(54) CABLE CARRIER

(71) Applicant: ICENINE INDUSTRIES, LLC, Bellevue, WA (US)

(72) Inventor: Dean M. Faith, Bellevue, WA (US)

(73) Assignee: ICENINE INDUSTRIES, LLC, Bellevue, WA (US)

(21) Appl. No.: 17/477,424

(22) Filed: Sep. 16, 2021

Related U.S. Application Data
(60) Provisional application No. 63/079,110, filed on Sep. 16, 2020.

(51) Int. Cl. F16L 3/015; F16G 13/18

(52) U.S. Cl. CPC F16L 3/015; F16G 13/18

(57) ABSTRACT

An apparatus for carrying cable, including: a first curve-limited drag chain facing in a first direction and including a plurality of channel-defining links, a second curve-limited drag chain facing in a second direction and including a plurality of channel-defining links, the second direction opposite the first direction, a transition link coupled between the first curve-limited drag chain and second curve-limited drag chain, a first mount coupled to an end of the first-curve limited drag chain, and a second mount coupled to an end of the second-curve limited drag chain.

### CROSS-REFERENCE TO RELATED APPLICATIONS

This invention claims priority, under 35 U.S.C. § 120, to the U.S. Provisional Patent Application No. 63/079,110 to Dean M. Faith filed on Sep. 16, 2020, which is incorporated by reference herein.

### FIELD OF THE INVENTION

The present invention relates to cable carriers, specifically to cable carrier connector linkages.

### DESCRIPTION OF THE RELATED ART

Cable carriers are used to support, protect, and guide wires, tubing, cables, and hoses such that they do not suffer damage. Further, cable carriers reduce wear and stress on lines within, and assist with containing and preventing lines from becoming tangled. Without them, cables hang free and are easily snagged, pinched, cut, or damaged by nearby objects.

In the related art, it has been known to use different cable carrier devices to protect the lines carried within, as well as to contain the lines such that they do not interfere with other objects in order to facilitate more durable and efficient systems. These cable carrier devices are oftentimes difficult to keep from sagging, kinking, or folding reliably and as such can become snared on or rub against nearby objects or pinch and damage the cable or the cable carrier itself. Accordingly, these devices oftentimes do not function or perform as well as intended.

Some improvements have been made in the field. Examples of references related to the present invention are described below in their own words, and the supporting teachings of each reference are incorporated by reference herein:

U.S. Patent Application Publication No. 2004/0083709, by Ikeda et al., discloses providing a cable and/or the like supporting and guiding device, by which a cable and/or the like can be easily incorporated into a chain and damage of the cable and/or the like and an accident of break in a cable can be minimized. A cable and/or the like supporting and guiding device comprises a chain (CH), a cable and/or the like (CB) disposed along the chain, and a support (20), which intersects the chain to support the cable and/or the like disposed on the chain. The support is composed of a material, which is flexed in the longitudinal direction of the cable and/or the like. In a curved section of the chain, when force is applied to the cable and/or the like, the support is flexed or bent in a direction of an action of force to ensure a length of the cable and/or the like, which is required for bending.

U.S. Patent Application Publication No. 2004/0084923, by Suzuki et al., discloses a cable guide (1) has a plurality of tubular links (11) consecutively connected to one another for pivoting about substantially parallel axes. At least some of the cables to be inserted into a cable guide (1) are flat cables (5) placed one over another so that the width of the flat cables (5) is parallel to the pivotal axes of the links (11) of the cable guide (1).

U.S. Patent Application Publication No. 2005/0056114, by Utaki, discloses providing a cable or the like protection and guide device, which reliably maintains linear position mode of the adjacent connecting link bodies without backlash to remove distortion and can attain a smooth change of form between the linear position mode and the bending position mode, and also can exert endurance due to the connecting pin and the pin connecting hole for a long period of time. A position limiting concave portion 110 a of a side plate 110, which connects link bodies 100 on the front and rear sides of a cable or the like protection and guide device 100 includes a pair of abutting surfaces 111, 111 disposed in parallel with a reference line passing through bending center points of connecting pins 130 disposed on the front and rear sides of the link body 100, and a position limiting convex portion 110 b of the side plate 110 includes a pair of linear position limiting surfaces 112, 112 disposed in parallel with each other in a plane symmetry with respect to the bending center point. Accordingly, bending of the linear position mode can be removed.

U.S. Patent Application Publication No. 2005/0269126, by Komiya, discloses a cable or the like protection and guide device which can suppress collision noise generated when adjacent link plates repeat a linear mode and a flexion mode to attain low noise, and can exhibit excellent wear resistance is provided. In a cable or the like protection and guide device (100), a C-shaped flexion guide groove (116) concentric with a connecting pin hole (115) is provided on a plate side (111) and V-shaped stopper surfaces (116 a) are formed on end portions of the C-shaped flexion guide groove (116). Further, a flexion guiding protrusion (117), which engages the C-shaped flexion guide groove (116), is provided on another link plate (111) connected to a connecting pin hole (115) side of the link plate (111) so that an arc-shaped contact surface (117 a) is formed on a protrusion outer circumferential portion of the flexion guiding protrusion (117). Thus, the arc-shaped contact surface (117 a) of the flexion guiding protrusion (117) makes point contact with the V-shaped stopper surface (116) of the C-shaped flexion guide groove (116) so that flexible movement of adjacent link plates (111), (111) are restricted.

U.S. Patent Application Publication No. 2007/0151225, by Ikeda et al., discloses a cable protection and guide device is disclosed which can reliably protect and guide cables without increasing and decreasing the width between link plates even if the height of the link plates of the cable protection and guide device is increased. The cable protection and guide device includes a number of link frame bodies each comprising a pair of right and left spaced link plates and upper and lower connecting rods respectively bridged on upper edge and lower edges of the link plates are connected to each other in the longitudinal direction of the device while restricting a flexion radius to a fixed value. A central connecting rod connects the pair of link plates at substantially the center portion along the height direction of the link plate. The central connecting rod is integrally molded with the pair of link plates.

U.S. Patent Application Publication No. 2013/0020290, by Epperlein, discloses a supply line routing device is described, for routing supply lines between connection points on components which are movable relative to each other, and having a sheathing with a changeable course. The supply line routing device comprises at least one guide channel for a supply line in the interior of the sheathing; and a plurality of retaining elements disposed in succession in the longitudinal direction of the sheathing on the outside thereof, which are configured to fasten at least one additional supply line to the outside of the sheathing.

The inventions heretofore known suffer from a number of disadvantages which include: allowing the chain to move freely, allowing the chain to make inconsistent and unrepeatable shapes when folded, taking up large amounts of space, being difficult to use, not allowing larger cables to be run, bending cables too much or too little, and damaging cables.

What is needed is an apparatus, system, or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available docking and mooring devices. Accordingly, the present invention has been developed to provide a satisfactory docking and mooring device.

There may be an apparatus for carrying one or more sections of cable or tubing, which may include a first curve-limited drag chain which may face in a first direction and may include a plurality of channel-defining links, a second curve-limited drag chain which may face in a second direction and may include a plurality of channel-defining links, the second direction may be opposite the first direction, a transition link which may be coupled between the first curve-limited drag chain and second curve-limited drag chain, a first mount which may be coupled to an end of the first-curve limited drag chain, a second mount which may be coupled to an end of the second-curve limited drag chain, the first curve-limited drag chain and the second-curve limited drag chain may each include a rotation restrictor which may prevent straightening of the links with respect to each other, a first rotation restrictor which may be functionally coupled between the first curve-limited drag chain and a first end of the transition link, a second rotation restrictor functionally which may be coupled between the second curve-limited drag chain and a second end of the transition link, the first and second rotation restrictor may each prevent straightening of the associated curve-limited drag chain with respect to the transition link but may be about rotation directions opposite one another, the transition link may not include an articulating channel cover, the transition link may be longer than any one of the channel-defining links of the first and/or second curve-limited drag chains, the transition link may include a first window and/or a second window, the second window may be opposite the first window, the first window and second window may be in inverse orientation with respect one another, the transition link may include a channel through which one end there may be access to the channel of the first curve-limited drag chain and through the other end there may be access to the channel of the second curve-limited drag chain, the first and second curve-limited drag chains may include articulating channel covers.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting us scope, the invention will be described and explained with additional specificity and detail through the use of the accompanying drawing(s), in which:

FIG. 1 is a top perspective view of a cable carrier, according to one embodiment of the invention;

FIG. 2 is a side elevational view of a cable carrier, according to one embodiment of the invention;

FIG. 3 is a top plan view of a cable carrier, according to one embodiment of the invention;

FIG. 4 is a side elevational view of a cable carrier, according to one embodiment of the invention; and

FIG. 5 is a cross-sectional view of a cable carrier, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

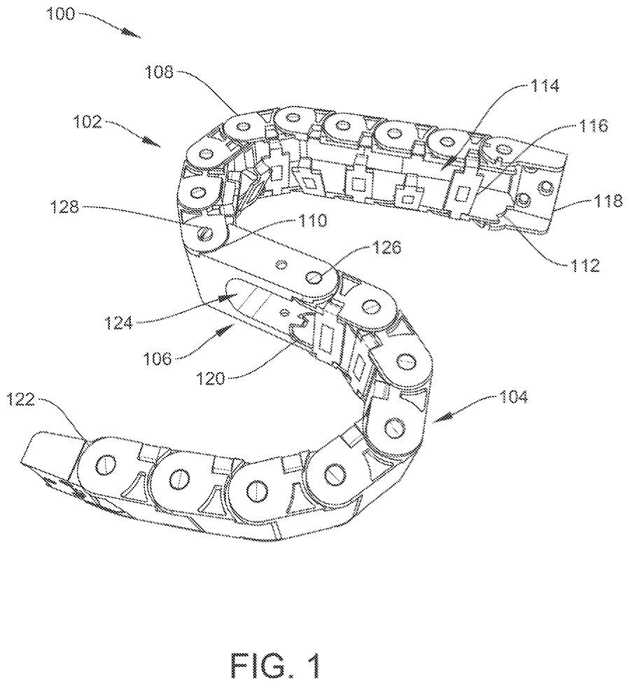

FIG. 1 is a top perspective view of a cable carrier, according to one embodiment of the invention. There is shown a cable carrier 100 including a first drag chain 102, a second drag chain 104 and transition link 106. The illustrated drag chains, 102 and 104, of the cable carrier 100 are curve-limited such that they are each able to flex in one direction, are flipped relative to one another, and are coupled via the illustrated transition link 106 such that the cable carrier 100 predictably and reliably compresses into an S-configuration in a consistent manner such that the cable carrier 100 does not pinch, twist, nor catch on surrounding objects.

The illustrated first drag chain 102 includes a plurality of links 108, a first end 110, and a second end 112. The plurality of links 108 are each hollow and when connected to other links define a channel 114 which is large enough to contain a plurality of cables within (e.g. power cables, network cables, USB cables). The plurality of links 108 each also include an articulating channel cover 116 which may be selectably rotated out of the way or removed such that a cable is easily able to be passed through the channel 114 formed by the plurality of links 108 without needing to feed it through one end of the drag chain 102. The illustrated plurality of links 108 are substantially identical to one another such that each link fits to each other link and moves predictably with respect to the other links, however in other embodiments the links may be different shapes and sizes.

The illustrated first end 110 of the first drag chain 102 is pivotally coupled to the transition link 106 such that it pivots in one direction relative to the transition link 106. In other embodiments, the first end 110 may pivot in multiple directions relative to the transition link 106. As illustrated, the first end 110 is a single drag chain link identical to the rest of the plurality of links 108, however in other embodiments may be a custom link or other mount piece which is able to better connect and move relative to the transition link 106.

The illustrated second end 112 of the first drag chain 102 is pivotally connected to a mount 118. The mount 118 allows the cable carrier 100 to be connected to any suitable structure. The mount 118 as shown is only able to pivot similarly to the rest of the first drag chain 102 and is shown as having slots wherein a fastener could secure mount 118 to and suitable surface. However, in other embodiments, the mount 118 may be coupled to the first drag chain 102 by other structure and may be able to connect to a suitable structure without the need for additional fasteners. Some examples of mounts may include, but are not limited to, clamps, hooks, straps, snaps, friction fit, and the like and combinations thereof.

The illustrated second drag chain 104 includes a plurality of links 108, a first end 120, and a second end 122. The plurality of links 108 are each hollow and when connected to other links define a channel 114 which is large enough to contain a plurality of cables within. The plurality of links 108 each also include a articulating channel cover 116 which may be selectably rotated out of the way or removed such that a cable is easily able to be passed through the channel 114 formed by the plurality of links 108 without needing to feed it through one end of the drag chain 104. The illustrated plurality of links 108 are substantially identical to one another such that each link fits to each other link and moves predictably with respect to the other links, however in other embodiments the links may be different shapes and sizes.

The illustrated first end 120 of the second drag chain 104 is pivotally coupled to the transition link 106 such that it pivots in one direction relative to the transition link 106. As illustrated, the direction the first drag chain 102 pivots is opposite the direction the second drag chain 104 pivots. In other embodiments, the first end 120 may pivot in multiple directions relative to the transition link 106. As illustrated, the first end 120 is a single drag chain link identical to the rest of the plurality of links 108, however in other embodiments may be a custom link or other mount piece which is able to better connect and move relative to the transition link 106.

The illustrated second end 122 of the second drag chain 104 is pivotally connected to a mount 118. The mount 118 allows the cable carrier 100 to be connected to any suitable structure. The mount 118 as shown is only able to pivot similarly to the rest of the second drag chain 104 and is shown as having slots wherein a fastener could secure mount 118 to and suitable surface. However, in other embodiments, the mount 118 may be coupled to the second drag chain 104 by other means and may be able to connect to a suitable structure without the need for additional fasteners. Some examples of mounts may include, but are not limited to, clamps, hooks, straps, snaps, friction fit, and the like and combinations thereof.

The transition link 106 is pivotally coupled to the first end 110 of the first drag chain 102 and to the first end 120 of the second drag chain 104 such that the first drag chain 102 pivots opposite the way the second drag chain 104 pivots. The transition link includes a channel 124, wherethrough a cable may be run. The illustrated transition link 106 has a set of female connectors 126 on one end and a set of male connectors 128 on the other end, however may have any combination or type of connectors such that the transition link 106 is able to mate with the first drag chain 102 and second drag chain 104. The illustrated transition link 106 includes mating structure that allows for pivoting in a direction consistent with each drag chain to which it is connected, which structures are opposite each other, since the drag chains each pivot opposite to each other. Thereby, the transition link forms a transition from one mode of pivoting to another mode of pivoting. The illustrated transition link 106 is longer than the adjacent links.

Although the illustrated embodiment is shown with a rectangularly shaped transition link 106 and links on the first and second drag chains, 102 and 104, in other embodiments the links may instead be any number of shapes, including but not limited to polygonal, ovoid, irregular, and the like and combinations thereof.

The structural pieces of the cable carrier 100 may be made of any material with a high strength-to-weight ratio, such as metals, hard and soft plastics, wood, and the like and combinations thereof. These materials may be plated, coated, or painted to assist in preventing exposure damage such as corrosion, chemical, or UV damage, as well as to provide antimicrobial or antistatic properties.

In operation, the cable carrier 102 is connected on one end via a mount 118 to a first structure, such as a wall, floor, desk, table, bracket, pole, or other structure or similar device. Once that connection is made, the remaining mount 118 is connected to a second structure similar to the first. Then, the articulating channel covers 116 are opened and each end of the cable is securely inserted through separate sides of the channel 124 of the transition link 106, and then each end of the cable is run through the channel 114 until the cable exits from each end of the cable carrier 100. Once the cable is fully run, the articulating channel covers 116 are fastened back to the drag chains, 102 and 104, and the device is ready to use.

Advantageously, the cable carrier 100 is a durable, effective, and ready-to-use device that is able to guide and protect cables so that they do not become tangled or damaged. The cable carrier 100 is also designed to have a large amount of strength and holding power while also minimizing the size of the unit and the space it takes up when folding and unfolding. The device also predictably folds and unfolds in a consistent manner, thereby allowing the user to set it up once and forget about adjusting it or having issues down the line.

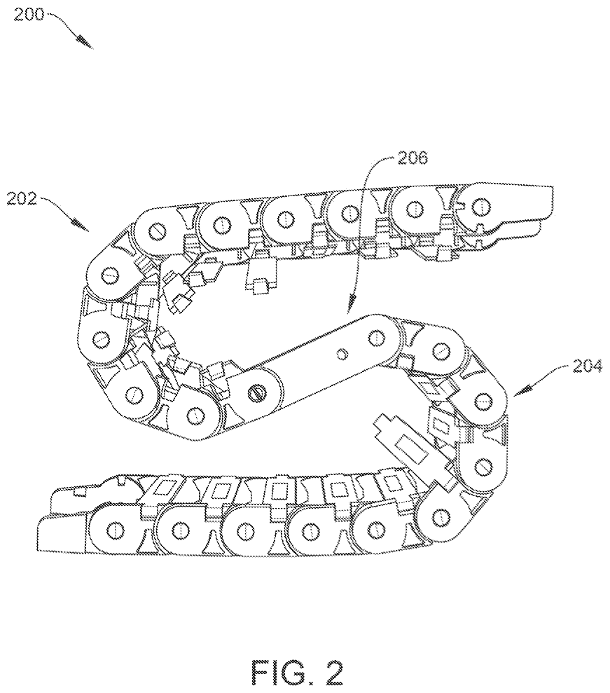

FIG. 2 is a side elevational view of a cable carrier, according to one embodiment of the invention. There is shown a cable carrier 200 in a folded state and first drag chain 202, a second drag chain 204, and a transition link 206 connected between the two drag chains, 202 and 204.

As shown, first drag chain 202, and second drag chain 204 are folded such that some of the sections are pivoted as far as they are allowed to go. These drag chains, 202 and 204, are intentionally limited such that the individual links do not bend so far between one another to kink or damage a cable running within a channel. Further, the drag chains are restricted from rotating past parallel on the other side. This is beneficial so that the cable carrier 200 retains structure rather than constantly bending back and forth and therefore does not collapse upon itself

The transition link 206 is shown connected to the two drag chains, 202 and 204, and flips the first drag chain 202 so that its sides are opposite the second drag chain 204. When paired with the restrictions on the drag chains, 202 and 204, the drag chains, 202 and 204, are only able to fold in opposite directions, forcing the cable carrier 200 to fold in a predictable and repeatable S-shape, while maintaining the ability to carry cable without kinking or twisting.

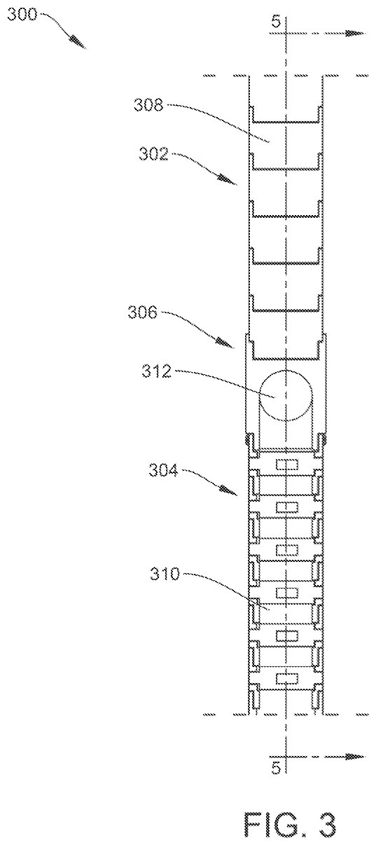

FIG. 3 is a top plan view of a cable carrier, according to one embodiment of the invention. The illustrated cable carrier 300 is shown in an uncompressed state, wherein the first drag chain 302, second drag chain 304, and transition link 306 are all substantially in line with one another. The illustrated first drag chain 302 and the second drag chain 304 are oriented opposite to each other such that their range of pivoting is also opposite.

The illustrated drag chains, 302 and 304, are shown facing opposite one another with the first side 308 of the first drag chain 302 showing and the second side 310 of the second drag chain 304 showing. One side of the transition link 306 is shown, and a window 312 can be seen running through the center of the transition link 306. The size and shape of the window 312 both determines the structural integrity the window 312 provides to the transition link 306, as well as determines the cables that may be run through the cable carrier 300, as any cable ends larger than the illustrated window 312, will be unable to be run through the transition link 306 properly. The other side of the transition link 306 is substantially similar to the shown side, however it is rotated 180 degrees. Accordingly, the windows on the shown side and the other side are in inverse orientation to one another.

In other embodiments, the transition link 306 may only have sides and be completely open in the middle to accept very large cable ends. In those embodiments, the sides of the transition link may be fortified or braced to provide the additional rigidity. In other embodiments, the transition link may not have a window 312 and may be covered on both sides, and/or the first side 308 and second side 310 may be identical, covered or not.

The illustrated transition link 306 also includes a channel in line with the channels formed by the first and second drag chains, 302 and 304, the channel running perpendicular to the window 312 in the transition link 306. A cable may be fed through the channel and window 312 in the transition link 306 such that the cable is able to run through the first drag chain 304, the transition link 306, and the second drag chain 304, without the cable exiting the cable carrier 300 at any point. In some embodiments, the sides of the transition link 306 may be coupled to the first and/or second drag chains, 302 and 304, such that they may be partially or fully disconnected to allow a cable to be fed through the channel in the transition link 306 without needing to feed it through the window 312. This would allow the transition link 306 to be fortified without restricting the size of cable the cable carrier 300 is able to handle. Further, it would allow a cable to be fed entirely through one side of the cable carrier 300.

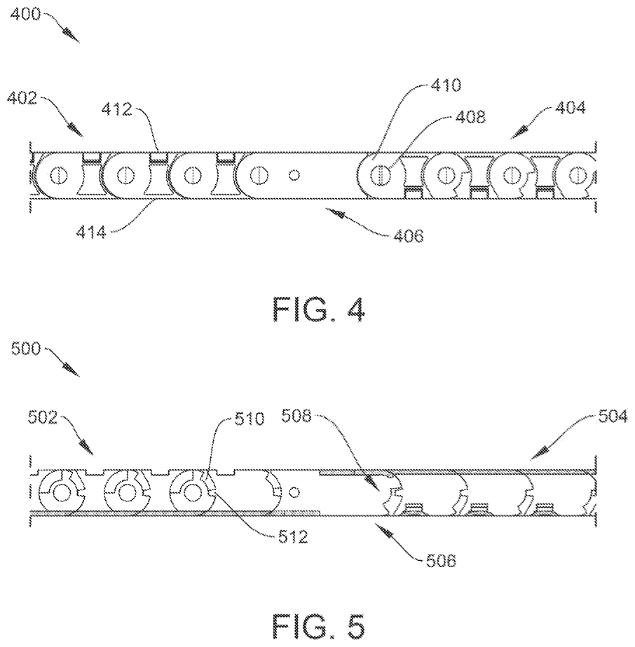

FIG. 4 is a side elevational view of a cable carrier, according to one embodiment of the invention. The illustrated cable carrier 400 is shown in an unfolded position; such that each of the links in the first drag chain 402 and second drag chain 404 are in line with one another as well as the transition link 406.

As illustrated, the links of the first drag chain 402, second drag chain, and transition link 406 each include male connectors 408 and female connectors 410. The male connectors 408 of each link are inserted into the female connectors 410 of adjacent links. The connectors allow the links to not only be connected, however, also to rotate freely with respect to one another with minimal resistance. In other embodiments, the male connectors 408 and female connectors 410 may be any number of connectors including but not limited to clip, snap, latch, press fit, and the like and combinations thereof.

As shown, the top side 412 of the first drag chain 402 is facing down, and the bottom side 414 is facing up. This is opposite the second drag chain 404, as the second drag chain 404 has the top side 412 facing up, and the bottom side 414 facing down. Additionally, the links of the first drag chain and second drag chain, 402 and 404, are facing the same direction front-to-back.

FIG. 5 is a cross-sectional view of a cable carrier, according to one embodiment of the invention. The illustrated cable carrier 500 is shown with a first drag chain 502 and a second drag chain 504. The links of the first and second drag chains, 502 and 504, and transition link 506 each contain rotation restrictors 508.

The illustrated rotation restrictors 508 include depressions 510 and outcroppings 512 which interconnect and contact one another at certain rotation distances. When contacting one another, the rotation restrictors restrict the links of the first and second drag chains, 502 and 504, from rotating too far in any one direction. In other embodiments, the rotation restrictors may be built into the outside of the links and/or may be any number of stops, including but not limited to pins or balls and depressions, poles, ratcheting and release, increasing friction slides, walls, latches, and the like and combination thereof.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the drag chains are illustrated as curve limited in order to better facilitate compressing and straightening without kinking or folding in only one direction, in some embodiments the drag chains may be able to flex or pivot in any number of directions. Parts or the entirety of the structure of the drag chains may also or instead be made of a material that has some elasticity or plasticity such that by design or if necessary, the rigid structure of the drag chains is able to compensate for twisting or curving further that it is designed before the drag chains suffer damage or loss of function.

Additionally, although the figures illustrate a single transition link, in other embodiments the cable carrier may contain additional transition links such that a longer cable carrier is able to fold compactly and predictably. An example is if it were to be used on a lift, where the cables are desired to be protected but cannot bow outside of the machine.

It is also envisioned that the rotation restrictors of the cable carrier include stiffer bracing or materials or are connected to supports such that they are significantly harder to kink, disengage from, or break. Further, the rotation restrictors may be coated with a material or lubricant such that the rotation restrictors both move with less resistance as well as less friction. In conjunction or separate from the strengthening, life span of the cable carrier may be increased.

It is expected that there could be numerous variations of the design of this invention. An example is that the cable carrier may instead of or in conjunction with the static pin connectors, may have depressible connectors such that the device is easier to assemble, add, subtract, or replace links.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A cable carrier, comprising:
a. A first curve-limited drag chain facing in a first direction and including a plurality of channel-defining links;
b. a second curve-limited drag chain facing in a second direction and including a plurality of channel-defining links, the second direction opposite the first direction;
c. a transition link coupled between the first curve-limited drag chain and second curve-limited drag chain;
d. a first mount coupled to an end of the first-curve limited drag chain; and
e. a second mount coupled to an end of the second-cure limited drag chain.

2. The cable carrier of claim 1, wherein the first curve-limited drag chain and the second-curve limited drag chain each include a rotation restrictor that prevents straightening of the links with respect to each other.

3. The cable carrier of claim 1, including:
a. a first rotation restrictor functionally coupled between the first curve-limited drag chain and a first end of the transition link; and
b. a second rotation restrictor functionally coupled between the second curve-limited drag chain and a second end of the transition link, wherein the first and second rotation restrictor each prevent straightening of the associated curve-limited drag chain with respect to the transition link but about rotation directions opposite one another.

4. The cable carrier of claim 1, wherein the transition link does not include an articulating channel cover.

5. The cable carrier of claim 1, wherein the transition link is longer than any one of the channel-defining links of the first or second curve-limited drag chains.

6. The cable carrier of claim 1, wherein the transition link includes a first window and a second window, the second window opposite the first window.

7. The cable carrier of claim 1, wherein the first window and second window are in inverse orientation with respect to one another.

8. The cable carrier of claim 1, wherein the transition link includes a channel through which one end there is access to the channel of the first curve-limited drag chain and through the other end there is access to the channel of the second curve-limited drag chain.

9. The cable carrier of claim 1, wherein the first and second curve-limited drag chains include articulating channel covers.

10. A cable carrier, comprising:
a. A first curve-limited drag chain facing in a first direction and including a plurality of channel-defining links;
b. a second curve-limited drag chain facing in a second direction and including a plurality of channel-defining links, the second direction opposite the first direction;
c. a transition link coupled between the first curve-limited drag chain and second curve-limited drag chain;
d. a first rotation restrictor on the first curve-limiting drag chain that prevents straightening of the links thereof with respect to each other; and
e. a second rotation restrictor on the second curve-limiting drag chain that prevents straightening of the links thereof with respect to each other.

11. The cable carrier of claim 10, including:
a. a first rotation restrictor functionally coupled between the first curve-limited drag chain and a first end of the transition link; and
b. a second rotation restrictor functionally coupled between the second curve-limited drag chain and a second end of the transition link, wherein the first and second rotation restrictor each prevent straightening of the associated curve-limited drag chain with respect to the transition link but about rotation directions opposite one another.

12. The cable carrier of claim 11, including a first mount that is coupled to an end of the first-curve limited drag chain.

13. The cable carrier of claim 12, including a second mount that is coupled to an end of the second-curve limited drag chain.

14. The cable carrier of claim 13, wherein the transition link includes a channel through which one end there is access to the channel of the first curve-limited drag chain and through the other end there is access to the channel of the second curve-limited drag chain.

15. The cable carrier of claim 14, wherein the transition link does not include an articulating channel cover.

16. cable carrier of claim 15, wherein the first and second curve-limited drag chains include articulating channel covers.

17. The cable carrier of claim 16, wherein the transition link is longer than any one of the channel-defining links of the first or second curve-limited drag chains.

18. The cable carrier of claim 17, wherein the transition link includes a first window and a second window, the second window opposite the first window.

19. The cable carrier of claim 18, wherein the first window and second window are in inverse orientation with respect to one another.

20. A cable carrier, comprising:
a. A first curve-limited drag chain facing in a first direction and including a plurality of channel-defining links;
b. a second curve-limited drag chain facing in a second direction and including a plurality of channel-defining links, the second direction opposite the first direction;
c. a transition link coupled between the first curve-limited drag chain and second curve-limited drag chain, wherein the transition link includes a channel through which one end there is access to the channel of the first curve-limited drag chain and through the other end there is access to the channel of the second curve-limited drag chain;
d. a first mount coupled to an end of the first-curve limited drag chain;
e. a second mount coupled to an end of the second-curve limited drag chain;
f. a first rotation restrictor functionally couple between the first curve-limited drag chain and a first end of the transition link; and
g. a second rotation restrictor functionally couple between the second curve-limited drag chain and a second end of the transition link, wherein the first and second rotation restrictor each prevent straightening of the associated curve-limited drag chain with respect to the transition link but about rotation directions opposite one another, the first curve-limited drag chain and the second-curve limited drag chain each include a rotation restrictor that prevents straightening of the links with respect to each other.
